(19) United States
(12) Patent Application Publication
(10) Pub. No.: US 2016/0044404 A1
(43) Pub. Date: Feb. 11, 2016

(54) SPEAKER APPARATUS

(71) Applicant: Koang Heui LEE, Hwaseong-si (KR)

(72) Inventor: Koang Heui LEE, Hwaseong-si (KR)

(21) Appl. No.: 14/921,428

(22) Filed: Oct. 23, 2015

Related U.S. Application Data
(63) Continuation of application No. PCT/KR2014/003640, filed on Apr. 25, 2014.

(30) Foreign Application Priority Data
Apr. 30, 2013 (KR) 10-2013-0047876

(51) Int. Cl. H04R 1/28; H04R 3/04; H04R 1/02

(52) U.S. Cl. CPC H04R 1/2826; H04R 1/02; H04R 1/2857; H04R 3/04

(57) ABSTRACT

A speaker apparatus including: a speaker cabinet in which an opening is formed in a front side; a speaker driver installed frontward in the opening of the speaker cabinet; and a duct part having a labyrinth structure that guides radiating acoustic energy of the speaker driver to a front duct hole formed in the front side of the speaker cabinet and a rear duct hole formed in a rear side of the speaker cabinet.

### CROSS-REFERENCE TO RELATED APPLICATIONS

The present application is a continuation under 35 U.S.C. §111(a) of International Patent Application No. PCT/KR2014/003640, filed on Apr. 25, 2014, which claims priority from Korean Patent Application No. 10-2013-0047876 filed on Apr. 30, 2013, each of which is hereby incorporated by reference for all purposes as if fully set forth herein.

### BACKGROUND

1. FIELD

Exemplary embodiments relate to a speaker apparatus. More particularly, exemplary embodiments relate to a speaker apparatus with a duct part having a labyrinth structure capable of implementing a low-pitched sound.

2. Discussion of the Background

A speaker or a speaker apparatus is an electromechanical converter that converts an electrical signal into a sound. Speakers may be classified into a horn type speaker and a cone type speaker according to a shape and may be classified into a dynamic type speaker, a magnetic type speaker, a condenser type speaker, and a crystal type speaker according to a driving principle.

Speakers may also be classified according to a pitch range. A sound of a high frequency has a short wavelength and a sound of a low frequency has a long wavelength. Hence, a small speaker is advantageous to reproduction of the sound of high frequency, and a large speaker is advantageous to reproduction of the sound of low frequency.

Therefore, if a speaker apparatus is small in size but can reproduce a wide band of sound, the speaker apparatus can be connected to various types of reproduction devices, such as mobile phones or tablet computers, and reproduce a sound of a grand scale even at a low volume.

Generally, when creating a broad frequency reproduction band, a sound of a low frequency band can be generated by increasing an efficiency value in a specific frequency band through an IC design, i.e., digital signal processor (DSP), in an amp. However, if a response frequency value in a frequency band, in which an efficiency value is to be increased, is not present or excessively lower than a limit value which an IC can amplify, it is difficult to extend an average sound pressure level to a desired frequency.

Recently, a broadband speaker using a pair of passive radiators has been launched. In the passive radiator, a diaphragm operates in response to inner air pressure of a speaker cabinet that is changed by a movement of a woofer on behalf of a bass-reflex port. However, a speaker apparatus using such passive radiators is a deluxe type and is expensive.

Therefore, there is a need for a speaker apparatus that has excellent sound field and is capable of implementing a low-pitched sound of a low frequency band by using a small speaker.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a speaker apparatus that is small in size, has excellent sound field, and is capable of implementing sound of a low frequency band.

Additional aspects will be set forth in the detailed description which follows, and, in part, will be apparent from the disclosure, or may be learned by practice of the inventive concept.

An exemplary embodiment discloses a speaker apparatus having a speaker cabinet with an opening and a front duct hole formed in a front side and a rear duct hole formed in a rear side. A speaker driver is installed frontward in the opening of the speaker cabinet. The speaker apparatus further includes a duct part having a first space part defined between the front side of the speaker cabinet and a first plate disposed to face the front side of the speaker cabinet, a second space part defined between the first plate and a second plate disposed to face the first plate, and a connection pipe connecting the rear duct hole and a hole formed in the second plate, such that radiating acoustic energy of the speaker driver is guided to the front duct hole and the rear duct hole.

An exemplary embodiment also discloses a speaker module having a front side with an opening and a front duct hole; a rear side with a rear duct hole; a speaker driver installed in the opening of the front side; and a duct part comprising a first inner space and a second inner space, in which at least one acoustic energy path is formed between the first inner space and the second inner space, wherein the at least one acoustic energy path is extended to the first duct hole and the rear duct hole.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a perspective view of a speaker apparatus according to an exemplary embodiment.

FIG. 2 is a front view of a speaker apparatus according to an exemplary embodiment.

FIG. 3 is a rear view of a speaker apparatus according to an exemplary embodiment.

FIG. 4 is a cross-section along the line A-A′ in FIG. 1.

FIG. 5 is a cross-section along the line B-B′ in FIG. 1.

FIG. 6 illustrates acoustic energy paths in a speaker apparatus according to an exemplary embodiment.

FIG. 7 illustrates acoustic energy paths in a speaker apparatus according to an exemplary embodiment.

FIG. 8 is an equivalent circuit diagram of a speaker apparatus according to an exemplary embodiment.

FIG. 9 is a graph showing a test result obtained using a speaker apparatus according to an exemplary embodiment.

### DETAILED DESCRIPTION OF ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. As such, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Hereinafter, the present invention will be described in detail with reference to the accompanying drawings.

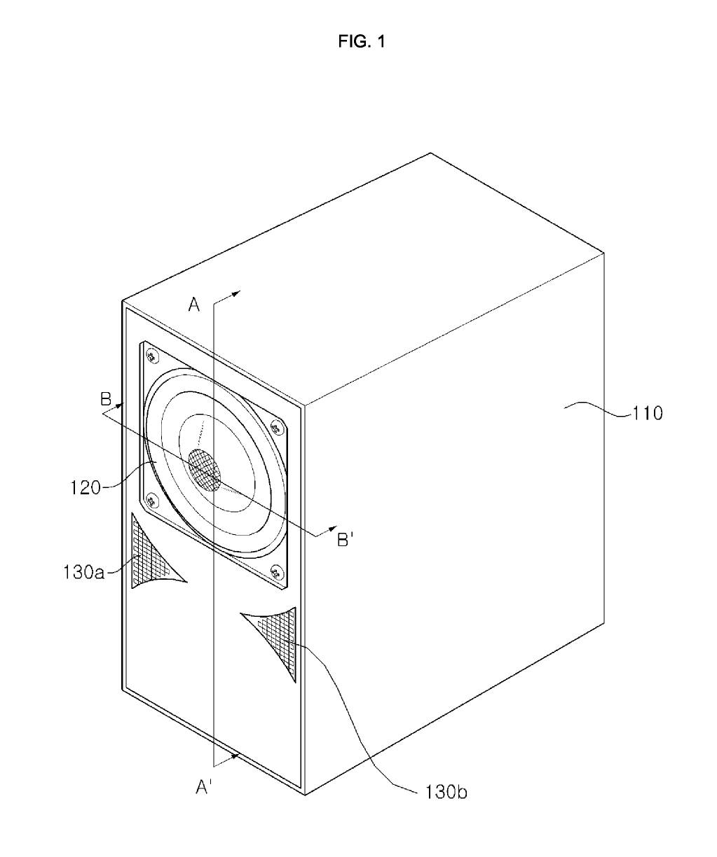

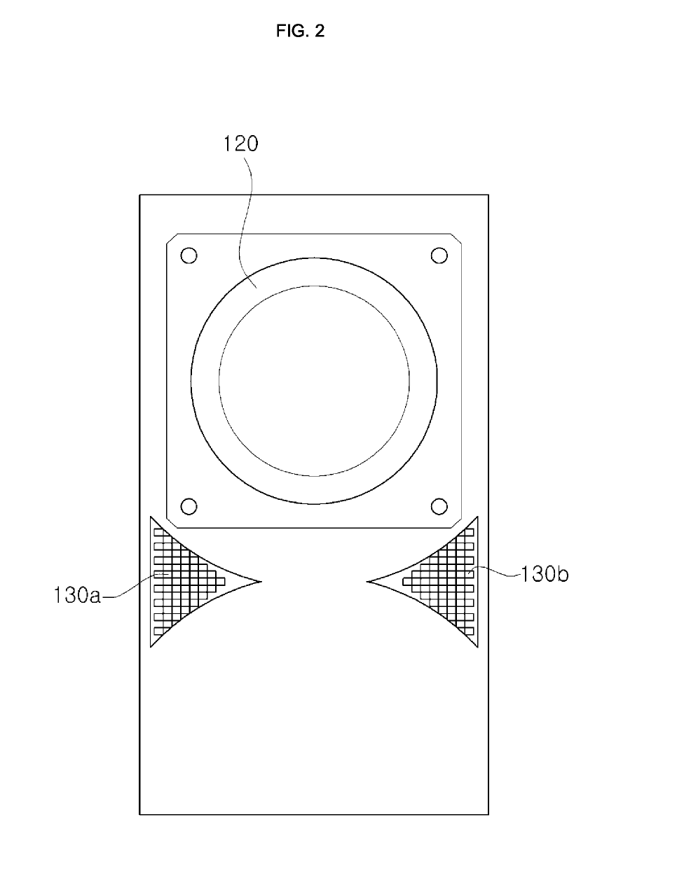

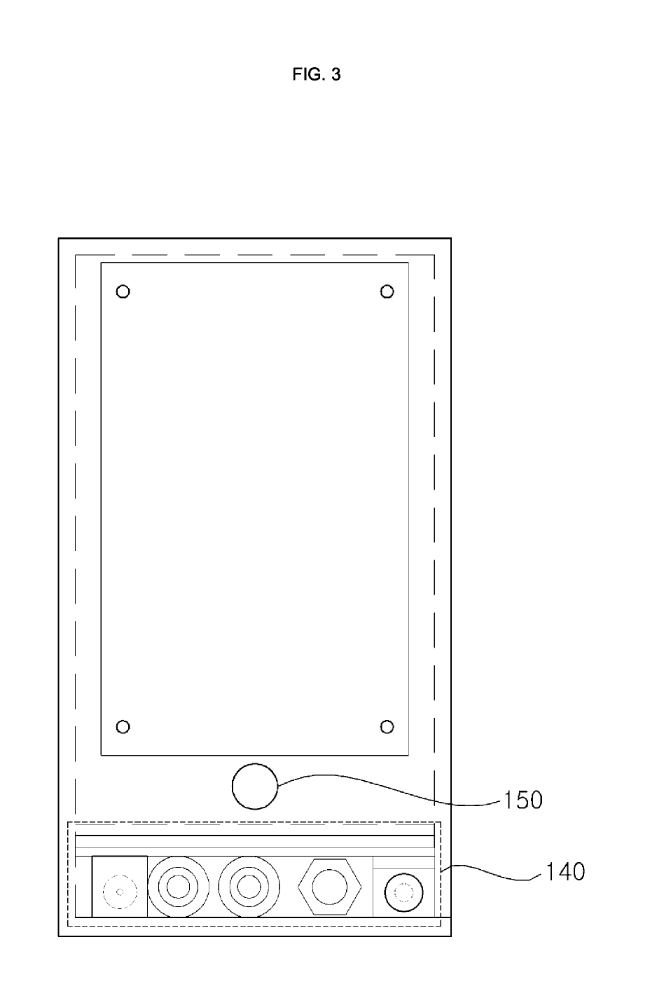

FIG. 1 is a perspective view of a speaker apparatus according to an exemplary embodiment, FIG. 2 is a front view of the speaker apparatus according to an exemplary embodiment, and FIG. 3 is a rear view of the speaker apparatus according to an exemplary embodiment. Components of the speaker apparatus according to the present invention will be described below with reference to FIGS. 1 to 3.

The speaker apparatus 100 includes a speaker cabinet 110 with an opening in a front side, and a speaker driver 120 installed frontward in the opening of the speaker cabinet 110. Front duct holes 130a and 130b are formed in the front side of the speaker cabinet 110. The speaker cabinet 110 may be made of wood or plastic.

A port part 140, in which connection ports for input/output of power, an audio signal, or the like are disposed, is installed in a rear lower portion of the speaker cabinet 110. A rear duct hole 150 is formed in a rear side of the speaker cabinet 110.

Inside the speaker cabinet 110, a duct part (not shown) having a labyrinth structure is installed so as to guide radiating acoustic energy of the speaker driver 120 to the front duct holes 130a and 130b and the rear duct hole 150 and implement a low-pitched sound of a low frequency band. A detailed structure of the duct part installed in the speaker cabinet 110 will be described below.

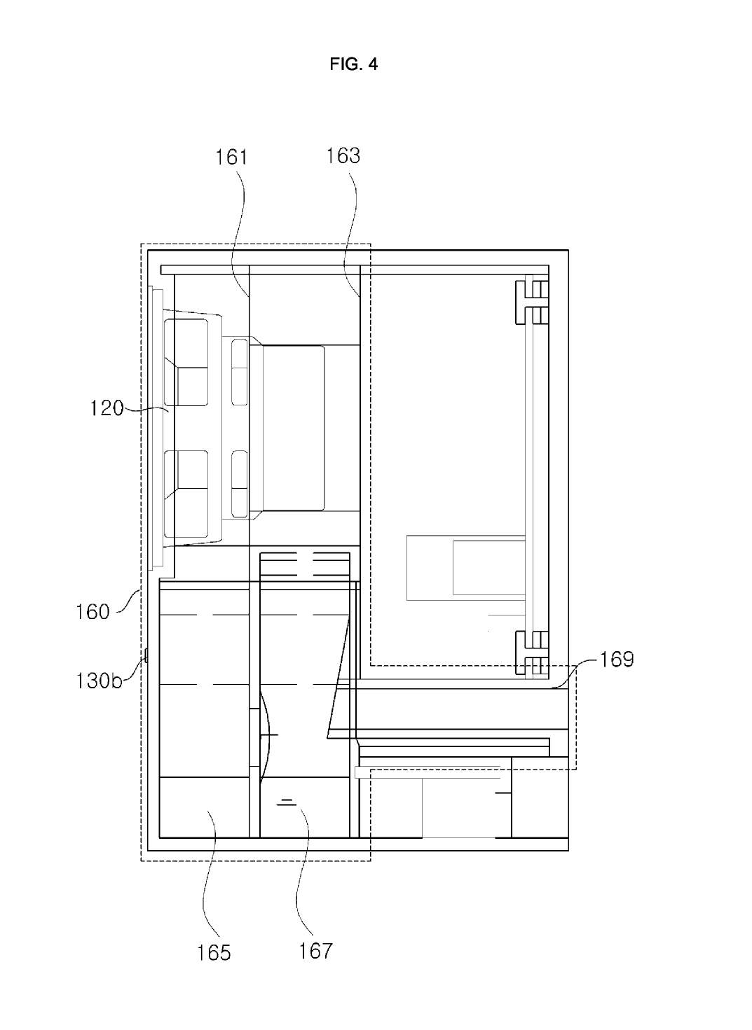

FIGS. 4 to 7 are diagrams for describing a structure of a duct part in the speaker apparatus according to an exemplary embodiment.

Referring to FIG. 4, a duct part 160 is partitioned by a first plate 161 and a second plate 163, which are disposed to face the front side of the speaker cabinet 110, into two space parts, i.e., a first space part 165 and a second space part 167. Specifically, the first space part 165 is defined between the front side of the speaker cabinet 110 and the first plate 161, and the second space part 167 is defined between the first plate 161 and the second plate 163. In the first plate 161 and the second plate 163, a connection path is installed so as to guide radiating acoustic energy between the first space part 165 and the second space part 167. The duct part 160 includes a connection pipe 169 for connecting the rear duct hole 150 and a hole formed in the second plate 163.

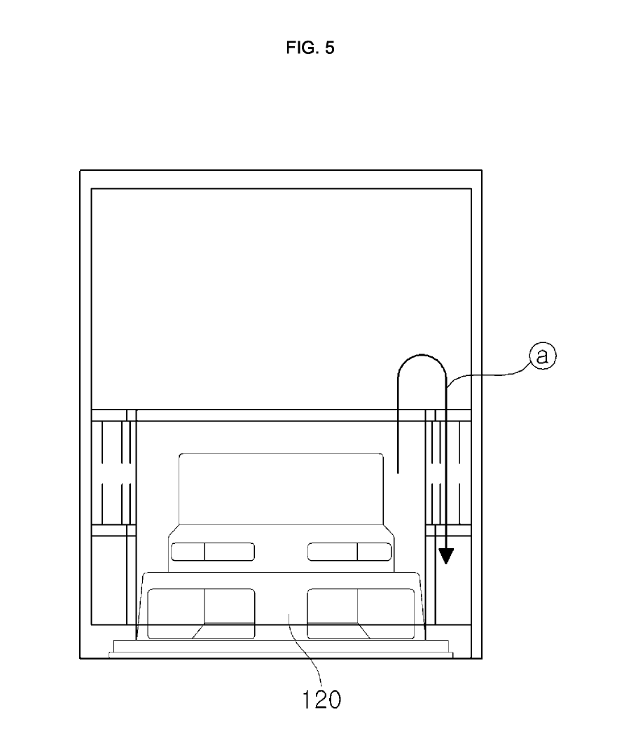

As shown in FIG. 5, the radiating acoustic energy of the speaker driver 120 moves from the second space part 167 to the lower end of the first space part 165 through both sides of the speaker driver 120 via path â.

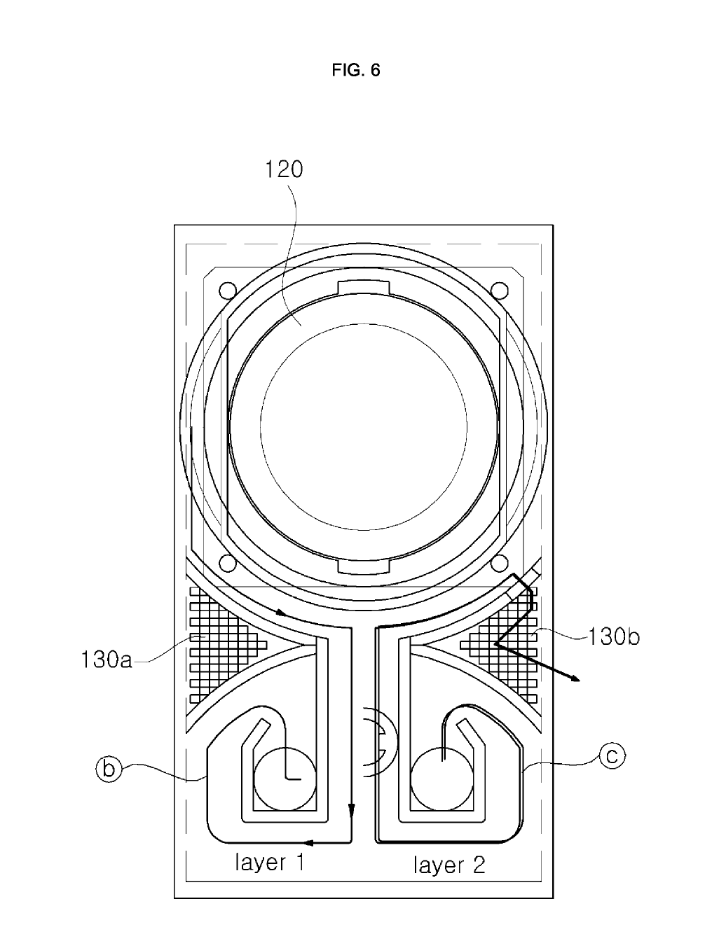

As shown in FIG. 6, the radiating acoustic energy guided to the lower end of the first space part 165 moves again to the second space part 167 along a path \hat{b} rotating clockwise, and moves again from the second space part 167 in an upward direction along a path ĉ rotating clockwise.

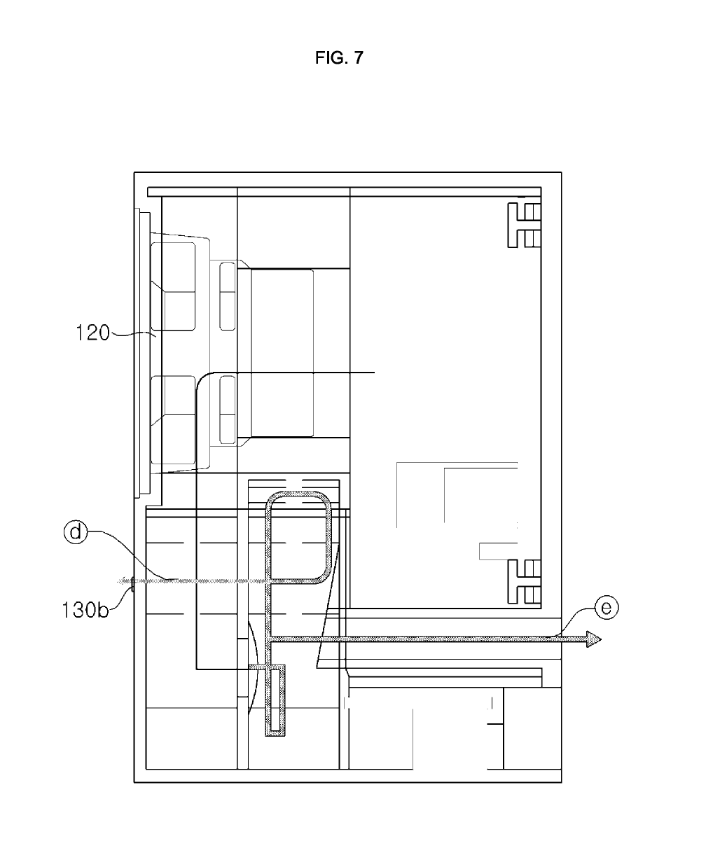

As illustrated in FIG. 7, a part of the radiating acoustic energy having moved from the second space part 167 in the upward direction is radiated through the front duct hole 130b in a front direction via path \hat{d}, and a part of the radiating acoustic energy is radiated through the connection pipe 169 and the rear duct hole 150 in a rear direction via path ê.

As a whole, the radiating acoustic energy is guided in the order of â→\hat{b}→ĉ→\hat{d}→ê. A part of the radiating acoustic energy is output to the front duct holes 130a and 130b, and a part of the radiating acoustic energy is output to the rear duct hole 150. The duct part 160 having such a labyrinth structure can implement a low-pitched sound by inducing the radiating acoustic energy to the outside by using a very long sound path passing through the two space layers.

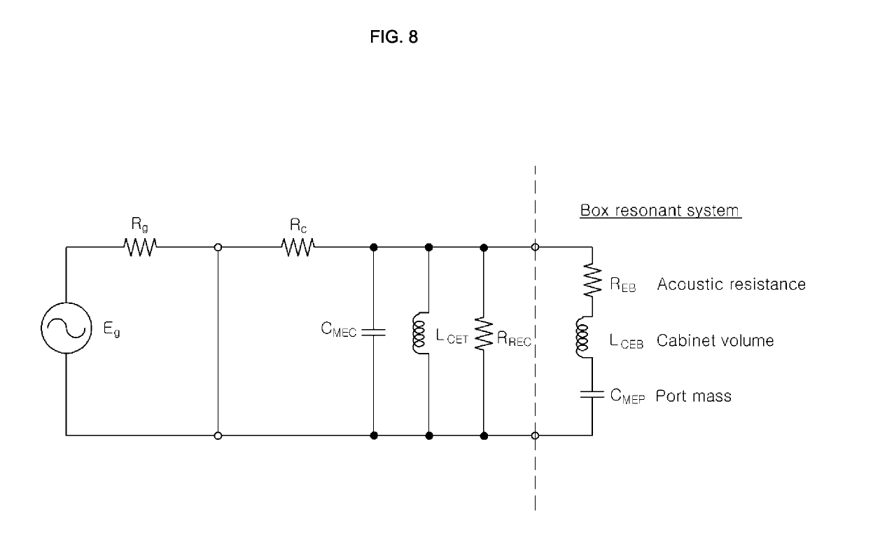

FIG. 8 is an equivalent circuit diagram of the speaker apparatus according to an exemplary embodiment.

Referring to FIG. 8, the speaker apparatus 100 guides the radiating acoustic energy to the outside at opposite angles through the front duct holes 130a and 130b and the rear duct hole 150 and implements similar effects to the case where the double-sided passive radiator is installed, thereby maximizing a port mass (C_{MEP}). Accordingly, a low-pitched sound can be implemented using a small speaker driver.

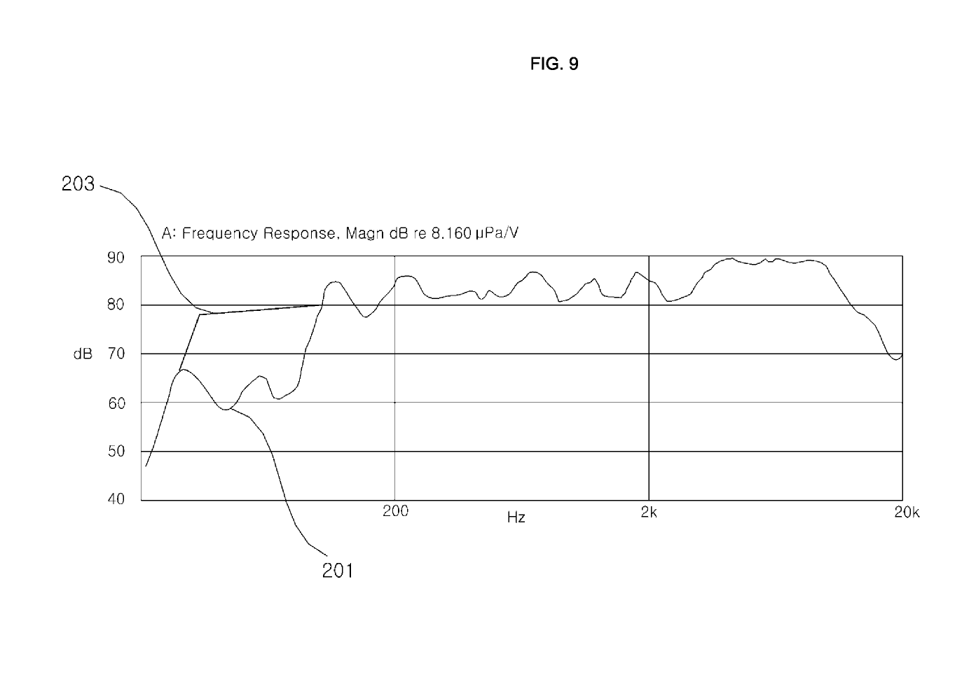

FIG. 9 is a graph showing a test result obtained using the speaker apparatus according to an exemplary embodiment.

Specifically, FIG. 9 shows a test result at a position ahead of 0.5 m from the speaker driver 120, without DSP. As shown in the graph indicated by reference numeral 201, it is possible to obtain a response value of 65 dB at a frequency of 35 Hz by using a 2.2-inch speaker driver.

Therefore, in a case where the DSP is added to the speaker apparatus 100, it is possible to obtain a response such as a graph waveform 203 indicated by reference numeral 203. Hence, it is possible to reproduce a broadband signal including a low frequency band. If the duct part 160 having the labyrinth structure is not present, a signal of a low frequency band is weak, and thus, it is impossible to reproduce a broadband signal even when the DSP is used.

The speaker apparatus according to the present invention is not limited to the above-described embodiments. All or part of the above-described embodiments may be optionally combined to make various modifications.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A speaker apparatus comprising:
a speaker cabinet comprising an opening and a front duct hole formed in a front side and a rear duct hole formed in a rear side;
a speaker driver installed frontward in the opening of the speaker cabinet; and
a duct part comprising:
a first space part defined between the front side of the speaker cabinet and a first plate disposed to face the front side of the speaker cabinet,
a second space part defined between the first plate and a second plate disposed to face the first plate, and
a connection pipe connecting the rear duct hole and a hole formed in the second plate, such that radiating acoustic energy of the speaker driver is guided to the front duct hole and the rear duct hole.

2. The speaker apparatus of claim 1, wherein the duct part comprises a path configured to guide the radiating acoustic energy from the second space part to a lower end of the first space part through both sides of the speaker driver, from the lower end of the first space part to a lower end of the second space part along a rotating path, and from the lower end of the second space part along a rotating path in an upper direction of the second space part, such that a part of the radiating acoustic energy is radiated through a hole formed in the first plate and the front duct hole in a front direction, and a part of the radiating acoustic energy is radiated through the connection pipe and the rear duct hole in a rear direction.

3. The speaker apparatus of claim 1, wherein a port part comprising connection ports for input or output of power and an audio signal is disposed in the rear side of the speaker cabinet.

4. The speaker apparatus of claim 3, further comprising a digital signal processing (DSP) configured to reinforce a signal of a specific frequency band in the audio signal and provide the reinforced signal to the speaker driver.

5. A speaker module comprising:
a front side comprising an opening and a front duct hole;
a rear side comprising a rear duct hole;
a speaker driver installed in the opening of the front side; and
a duct part comprising a first inner space and a second inner space, in which at least one acoustic energy path is formed between the first inner space and the second inner space,
wherein the at least one acoustic energy path is extended to the front duct hole and the rear duct hole.

6. The speaker module of claim 5, wherein the first inner space is formed between the front side and a first plate, and the second inner space is formed between the front side and a second plate.

7. The speaker module of claim 6, wherein the second inner space comprises a first acoustic energy path configured to receive acoustic energy generated from the speaker module and to pass the acoustic energy to the first inner space.

8. The speaker module of claim 7, wherein the first acoustic energy path is formed along a right side or left side of the speaker driver.

9. The speaker module of claim 7, wherein the first acoustic energy path comprises two substantially symmetrical acoustic energy paths formed along a right side and left side of the speaker driver, respectively.

10. The speaker module of claim 7, wherein the first inner space comprises a second acoustic energy path configured to receive the acoustic energy from the first inner space and to pass the acoustic energy to the second inner space.

11. The speaker module of claim 9, wherein the second acoustic path is configured in a clockwise or counter-clockwise direction.

12. The speaker module of claim 9, wherein the second acoustic energy path comprises two substantially symmetrical acoustic energy paths respectively extended from the first acoustic energy path.

13. The speaker module of claim 7, wherein the second space further comprises a third acoustic energy path configured to receive the acoustic energy from first inner space and to pass the acoustic energy to the front duct hole.

14. The speaker module of claim 13, wherein the third acoustic energy path comprises two substantially symmetrical acoustic energy paths respectively extended from the second acoustic energy path.

15. The speaker module of claim 7, wherein the second space further comprises a fourth acoustic energy path configured to receive the acoustic energy from first inner space and to pass the acoustic energy to the rear duct hole.

16. The speaker module of claim 15, wherein the fourth acoustic energy path comprises two substantially symmetrical acoustic energy paths respectively extended from the third acoustic energy path.

17. The speaker module of claim 16, wherein the fourth acoustic energy path is formed through a pipe connecting the second inner space to the rear duct hole.

18. The speaker module of claim 17, wherein the second plate comprises an opening which the pipe is connected to.

19. The speaker module of claim 5, wherein the front duct hole comprises a left front duct hole and a right front duct hole.

20. The speaker module of claim 5, further comprising a speaker cabinet comprising the front side and the rear side.
